(19) United States
(12) Patent Application Publication
(10) Pub. No.: US 2008/0092594 A1
(43) Pub. Date: Apr. 24, 2008

(54) Automatic machine and automatic method for grinding the edges of glass panes

(75) Inventors: Fortunato Vianello, Vallio di Roncade (IT); Dino Moschini, Roncade (IT)

Correspondence Address: MODIANO & ASSOCIATI, Via Meravigli, 16, Milan, 20123, omitted

(73) Assignee: FOR.EL.BASE DI VIANELLO FORTUNATO & C. S.N.C.

(21) Appl. No.: 11/907,539

(22) Filed: Oct. 15, 2007

(30) Foreign Application Priority Data
Oct. 19, 2006 (IT) TV2006A000184

(51) Int. Cl. C03C 15/00

(52) U.S. Cl. 65/61

(57) ABSTRACT

An automatic machine and a related method for grinding the arrises of glass panes, provided with devices which allow to work glass panes which are rectangular or optionally contoured, at the arrises thereof, with rigid tools, such as diamond grinding wheels, by acting simultaneously but independently on the two mutually opposite arrises along the perimeter of the pane. The machine has at least one pair of mutually opposite working heads, each working head being provided with a tool which can be moved by floating toward the arris of the glass pane which is independent of the approach of the opposite tool. By way of the combined action of movement of the glass pane and of at least one pair of working heads it is also possible to work glass panes which have a nonrectangular shape.

### BACKGROUND OF THE INVENTION

Techniques for grinding (or, in the jargon, “arrissing”) the edges of glass panes as produced by cutting to the final formats for use are currently known. In principle, grinding can be applied to any step of the working of the glass pane, for example before the manufacture of the double-glazing unit or before tempering.

Grinding is performed for two reasons: the first relates to safety in handling the panes, in which the arrises would be dangerously sharp if they were not ground.

The second reason relates to elimination of border defects of the panes, typically so-called “microcracks”, which might trigger breakages in the pane in the subsequent working steps (particularly in the tempering step) and in the subsequent state for use (for example in the door or window).

In order to better understand the configuration of the glass pane, not so much in its possible use on its own but especially in its use in combination with other components to constitute the so-called double-glazing unit, some concepts related to said semifinished component, i.e., the “glass pane”, and the final product, i.e., the double-glazing unit, are summarized hereinafter. The subsequent use of the double-glazing unit, i.e., as a component of door or window, is known to the person skilled in the art and is not discussed here in detail.

With reference to FIG. 1, the double-glazing unit is constituted typically by two or more glass panes 1001, 1002, which are mutually separated by one or more internally hollow spacer frames 1003 provided with microperforations on their face directed toward the inside of the chamber.

The spacer frames 1003 usually contain, in their hollow part, hygroscopic material, which is not shown in the figure. A chamber (or chambers) 1006 delimited by the glass panes 1001 and 1002 and by the frame 1003 can contain air or gas or mixtures of gases injected therein, which give the double-glazing unit particular properties, for example heat-insulating and/or soundproofing properties. The connection between the glass panes and the frame is achieved by means of two levels of seal: a first seal 1004 is intended to provide a hermetic closure and affects the lateral surfaces of the frame 1003 and the portion adjacent thereto of the glass panes (1001, 1002); a second seal 1005 affects the compartment constituted by the outer surface of the frame and by the faces of the glass panes up to their edge and is intended to provide cohesion among the components and maintain the mechanical strength of the joint between them.

FIG. 1 illustrates five of the many possible sectional views of configurations of a double-glazing unit 1A, 1B, 1C, 1D, 1E, of which only the first one has been commented. However, it is straightforward to extend such illustration to the configurations 1B-1E, in which there are a plurality of frames or glass panes, the latter being optionally laminated. In the figure, the sun represents schematically the outside environment of a building in which the double-glazing units are installed, while the interior of the building is represented schematically by a radiator.

The “glass panes” used in the composition of the double-glazing unit can have various shapes depending on use: for example, the outer glass pane 1001 (with respect to the building) can be normal or selective or reflective (in order to limit thermal input during summer months) and can also be laminated/armored (for intrusion prevention/vandalism prevention functions) or can be laminated/tempered (for safety functions) and can also be combined, for example reflective and laminated.

The inner glass pane. 1002 (with respect to the building) can be normal or of the low-emissivity type (in order to limit heat dispersion during winter months) and can also be laminated/tempered (for safety functions) and combined, for example of the low-emissivity type and laminated.

The simple overview presented above already makes it evident that a manufacturing line, in order to obtain the double-glazing product, requires many processes in sequence and requires both the intermediate components (i.e., the glass panes) and the finished product (i.e., the double-glazing unit) to have glass pane edges which are accessible to contact with the hands of operators and users. It is therefore important to increase safety by beveling the peripheral borders of the glass panes. If the finished product, which has a considerable added value with respect to the individual pane, had pane edges which can cut or panes with a sharp edge, it would be degraded in terms of quality and commercial value.

The processes for producing the double-glazing unit are typically numerous, and each one requires a corresponding and particular machine to be arranged in series with respect to the other complementary machines. By way of non-exhaustive example, some processes or operations, which might not all be required, are as follows:

EDGING on the peripheral face of the pane of any coatings, in order to allow and maintain overtime the adhesion of the sealing agents;

WASHING of the individual glass panes, alternating inner pane and outer pane (the orientation being the one defined above);

APPLICATION OF THE SPACER FRAME: the previously manufactured frame, filled with hygroscopic material and covered on its lateral faces with an adhesive sealant, which has sealing functions, is applied to one of the glass panes that constitutes the double-glazing unit in an appropriately provided station of the double-glazing unit production line;

MATING AND PRESSING of the assembly constituted by the glass panes and the frame (or frames);

FILLING WITH GAS of the chamber (or chambers) thus obtained;

SECOND SEALING.

The processes listed above can be performed by the respective machine automatically or semiautomatically, but in any case entail the contact of the intermediate components and of the finished products with the operator, for example during loading and unloading of the line and in the subsequent steps for storage, transport, fitting and installation of the double-glazing units.

As regards grinding, which is not included in the list of processes cited above, in the known manual method the glass panes which rest on supporting surfaces are placed in contact with grinders provided with flexible abrasive belts which are arranged sequentially and are angularly offset so as to bevel both arrises of the side of the panes (methods of this type are disclosed for example in DE-A 44 19 963). EPA. 98890257.3 discloses an apparatus for beveling cut glass panes with an automatic process which uses a pair of flexible abrasive belts.

The greatest drawbacks that arise from the known manual and automatic methods described above relate to the considerable bulk of the machines, to the complex operations for process maintenance (such as replacement of the abrasive belts), the less than ideal quality of the grinding operation, the abnormal behavior of the belt in interaction with the glass pane when its width does not mate completely with the glass pane (i.e., at the end of the side of the glass pane), and finally the excessively long production times. In the case of automatic apparatuses (EPA. 98890257.3 and others which are not referenced), there is also the drawback of excessive cost due to the complexity of the mechanisms as provided.

The applicant of the present application is also the applicant for applications EPA. 04013951.1 and EPA. 06121234.6, which refer to machines and methods which perform grinding automatically and eliminate all the problems related to grinding by means of flexible abrasive belts because they use rigid abrasive grinding wheels instead of flexible abrasive belts. The drawback of cost also is reduced, but not yet to levels which allow extensive and interesting diffusion of the grinding machine.

### SUMMARY OF THE INVENTION

The aim of the present invention is to solve the above-mentioned problems, eliminating all the drawbacks of the background art, by providing a machine which allows to grind the edges of glass panes safely and cheaply, obtaining a qualitative result which is superior to the result of the background art which uses flexible abrasive belts and is equivalent to the result of the background art which uses rigid abrasive grinding wheels, but by resorting to a machine and a method which are simpler and therefore cheaper.

Within this aim, an object of the present invention is to simplify the mechanisms that constitute the automation of the grinding operation.

Another object is to not alter the structure of the production line of the double-glazing unit, obtaining an advantage from the modularity that typically characterizes it.

Another object is to ensure a symmetrical grinding of the edges, regardless of the surface and geometric irregularity of the edge of the glass pane or laminated glass panes produced by the operations for cutting the glass into the formats required for final use.

Another (optional) object is to perform grinding in a manner which is substantially independent of the shape of the perimetric profile of the glass pane.

Another object is to increase productivity by reducing the process time.

This aim and these and other objects which will become better apparent hereinafter are achieved by an automatic machine for grinding the edges of substantially flat glass panes, characterized in that it comprises a machine body and at least two mutually opposite working heads, which constitute the “pair” (in a version which performs work both on rectangular glass panes and on contoured, non-rectangular, glass panes, one or two pairs of working heads are sufficient), adapted to place the contained tools (rigid abrasive grinding wheels) in contact with the edges of the glass pane, each movable independently of the other toward and away from the edge of the glass pane, each of said working heads comprising an abrasive tool, which by way of nonlimiting example is frustum-shaped with an active face which can move substantially transversely to the plane of the glass pane (so-called adjustment motion in the etymology of machine tools).

The relative motion between the working heads and the glass pane (either or all of which can be moving simultaneously in the case of glass panes with a nonrectangular contour) constitutes, in the etymology of machine tools, the so-called feed or advancement motion.

Advantageously, in the case of a version with four pairs of working heads, of which three pairs can move vertically along a common axis, a version which is cheaper both as regards the machine, since it is simpler, and as regards the method, since it has a higher productivity, which allows to machine only rectangular panes, three of said pairs can move so that they are vertically rigidly coupled to a single slider which runs along a pair of guides which are arranged equally in front of or behind the glass pane.

Advantageously, in the case of a version in which the at least two working heads (each set of two constituting the pair) can move vertically and independently of each other along guides which are arranged in a mutually opposite position with respect to the plane of the glass pane, it is possible to work glass panes which have a nonrectangular shape, for example a polygonal shape composed entirely of straight sides or multiform, i.e., composed of portions which can be rectilinear or curvilinear, preferably but not necessarily having a base portion constituted by a rectilinear side.

Advantageously, the glass pane has a vertical arrangement, rests on a sliding surface and can move horizontally on a conveyor.

The arrangement referenced as vertical is actually slightly inclined with respect to the vertical plane (generally by 6°) in order to give static stability to the glass pane, i.e., prevent its tipping.

### BRIEF DESCRIPTION OF THE DRAWINGS

Further characteristics and advantages of the invention will become better apparent from the following detailed description of some embodiments of the invention, illustrated by way of nonlimiting example in the accompanying drawings, wherein:

FIGS. 1A-1E are partial sectional views of a series of typical configurations of a double-glazing unit;

FIG. 2 is a perspective general view of the machine which incorporates the invention, without the components shown more clearly in FIG. 4;

FIG. 3 is a perspective general view of the body of the machine which incorporates the invention, without the components shown more clearly in FIG. 4;

FIG. 4 is a perspective view of the mutually opposite working heads, particularly of the lower ones (section 100) and of the grinding method of the tools provided with an adjustment motion and with a cutting motion toward the lower side of the glass pane, which has an advancement or feeding motion;

FIGS. 5A and 5B are perspective detail views of the components of one of the working heads (the head of the assembly 100, on the operator's side, which however is also representative of the heads of the assemblies 200, 300, 400) which constitute the pair, clearly showing the support and actuation mechanisms which allow to move the active face of the tool (diamond bevel grinding wheel) toward and away from the glass pane, as well as the mechanisms which allow the working rotation (known as cutting motion in the etymology of machine tools) of the rigid abrasive grinding wheel, an also showing the detail of the frustum-shaped rigid abrasive grinding wheel;

FIG. 6 is a perspective detail view of the components of the working heads that belong to the pair of the type 200 in their connection to the sliders which run along the vertical axis Va or Vp or Vu which include the mechanisms for rotation about the axis Θa or Θp, which are present and active only in the optional configuration for a machine for rectangular and contoured glass panes (where Va is an acronym for vertical forward axis and Vp is an acronym for the vertical rear axis, Θa is an acronym for front traverse axis and Θp is an acronym for rear traverse axis);

FIG. 7 is a perspective view of the part of the machine that actuates the vertical movements of the working heads along the single vertical axis Vu (where Vu is an acronym for the single vertical axis);

FIG. 8 is a perspective view of the part of the machine that actuates the vertical movements of the working heads along the independent vertical axes Va and Vp (where Va is an acronym for front vertical axis and Vp is an acronym for rear vertical axis);

FIG. 9A is a view of a detail of the mechanisms of the type of a drive with partly motorized and partly idle rollers which support the glass plane along the horizontal axis H; the figure also shows the pivoting axes f2a and f2p of the lower working heads (section 100) for their spacing, which is required in order to avoid interference with the other working heads of the other sections;

FIG. 9B is a view of a detail of the mechanisms of the type of a drive with mutually opposite motorized rollers which move the glass pane along the horizontal axis H;

FIG. 10 is a general view of the mechanisms according to FIGS. 9A and 9B and of their interaction with the glass pane 1;

FIGS. 11A and its completion 11B illustrate the working principles respectively for a machine and the steps of a method which use a single vertical axis Vu to move multiple pairs (specifically and advantageously, three to contain the cost of the machine and to optimize the working cycle) of mutually opposite working heads; for the sake of clarity of the drawing, only the front frustum-shaped tools are shown, the rear ones being slightly offset so as not to interfere with the front ones if the glass pane is a few millimeters thick;

FIGS. 12A and its completion 12B illustrate the working principles respectively for a machine and the steps of a method which use two independent vertical axes Va and Vp which are mutually opposite with respect to the plane of the glass pane, for the movement of one or more pairs of mutually opposite working heads which are not mutually connected; for each pair of working heads, the front tools are shown in solid lines and the rear tools are shown in broken lines;

FIGS. 13A-13D are views showing shapes of the glass panes that can be worked with the machines and the methods according to the present invention and relate to the case of mutually opposite heads which are not mutually connected;

FIG. 14 is a view showing an example of insertion of the machine according to the invention in the line for production of the insulating glass (in a front elevation view);

FIG. 15 is a view showing an example of insertion of the machine according to the invention in the line for production of the insulating glass (in a plan view) and includes the identifiers of the main body, of the input and output conveyors, of the water treatment system, of the electrical/electronic panel, of the control post, and of the safety devices;

FIGS. 16A and 16B are realistic sectional views of the edge of the glass pane as they appear after the cutting process, respectively in the case of monolithic glass and in the case of laminated glass, in comparison with the situation of some background art.

### DESCRIPTION OF THE PREFERRED EMBODIMENTS

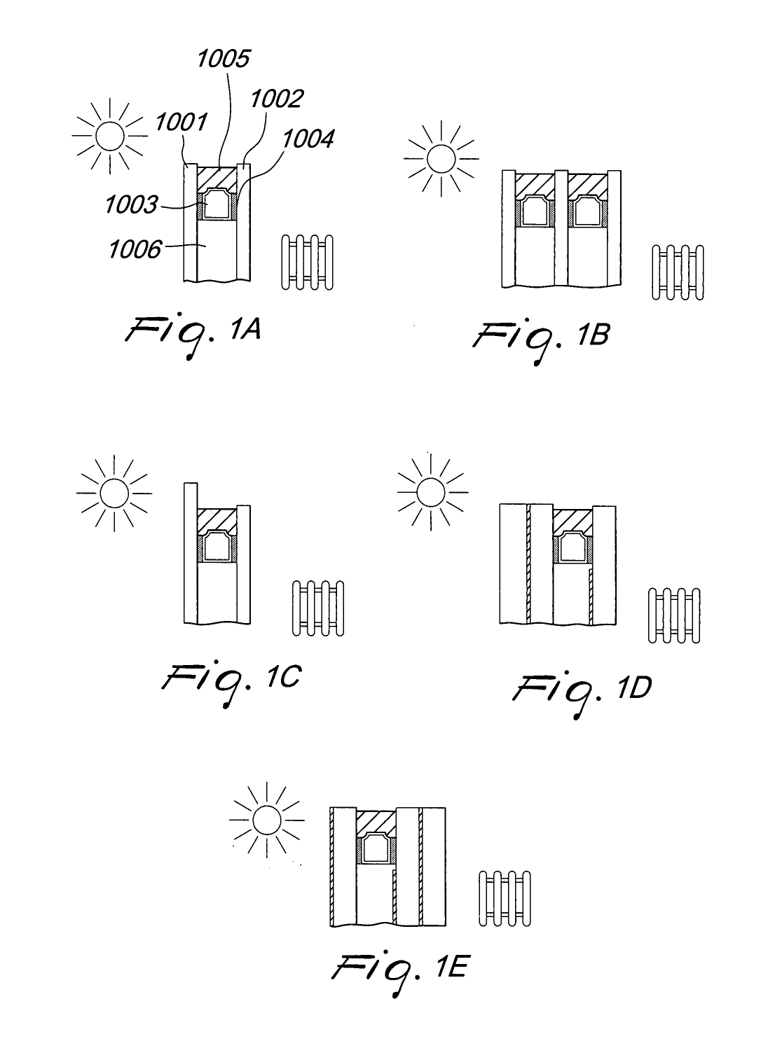

As described previously, FIG. 1 illustrates schematically the peripheral, portion of the double-glazing unit according to an exemplifying series of possible combinations: normal configuration (1A), triple glazing unit (1B), offset glass panes (1C), laminated outer pane and low-emissivity inner pane (1D), tempered reflective outer pane and laminated low-emissivity inner pane (1E). The two types of sealant used are highlighted: butyl sealant 1004, which has a sealing function (first seal) and is applied between the lateral surfaces of the frame and the glass panes, and polysulfide or polyurethane or silicone sealant 1005, which is intended to provide mechanical strength (second seal) and is applied between the outer surface of the frame and the inner faces of the glass panes up to their edge.

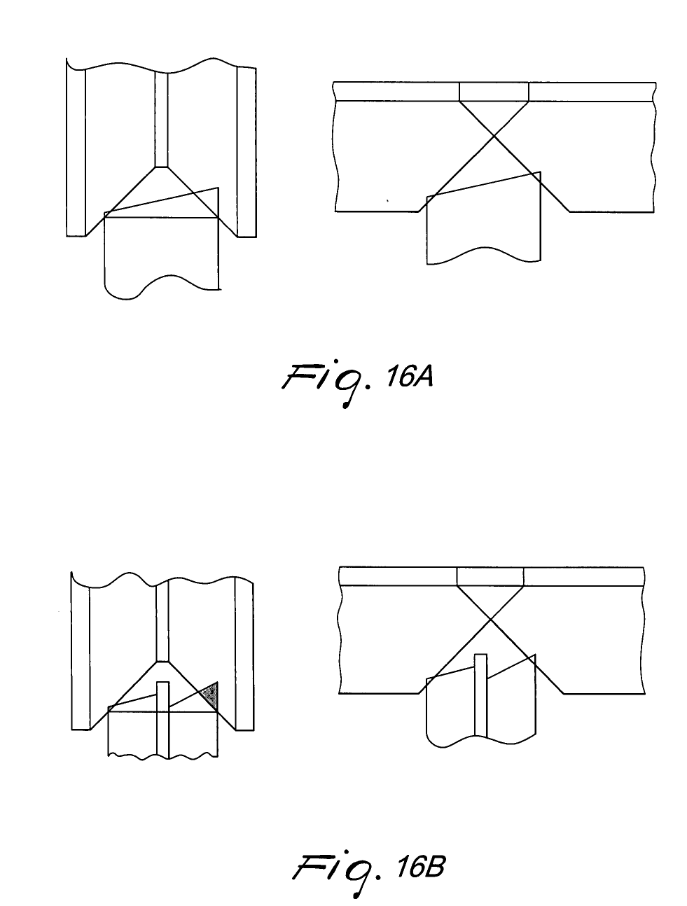

FIG. 1 shows that even after the second seal the double-glazing unit has the two outer perimeters which are particularly dangerous due to the sharpness of the arrises of the glass panes. It is in fact known that the border of a glass pane obtained by mechanical cutting (scoring with a diamond tool and subsequent breakage by localized flexing) has edges which are as sharp as a sharp blade. It is also known that the edge of cut glass panes is never perfectly perpendicular to the plane of the glass panes but is typically inclined, as shown by way of example in FIGS. 16A and 16B.

With reference to the figures, single-digit numerals designate the main assemblies of the machine so as to have an overview thereof, the reference numeral 1 designating a glass pane as the material being processed, while the constructive mechanisms and details are designated by three-digit numerals, in which the first digit is the digit of the main assembly to which they belong, and four-digit numerals designate the components of the double-glazing unit and the machines that belong to the production line thereof.

The reference numeral 1 designates the single “glass” pane, the sides of which are respectively designated as follows: the vertical front side 1a, the upper horizontal longitudinal side 1b and the lower horizontal longitudinal side 1c (machined simultaneously along certain portions), and the vertical rear side 1d.

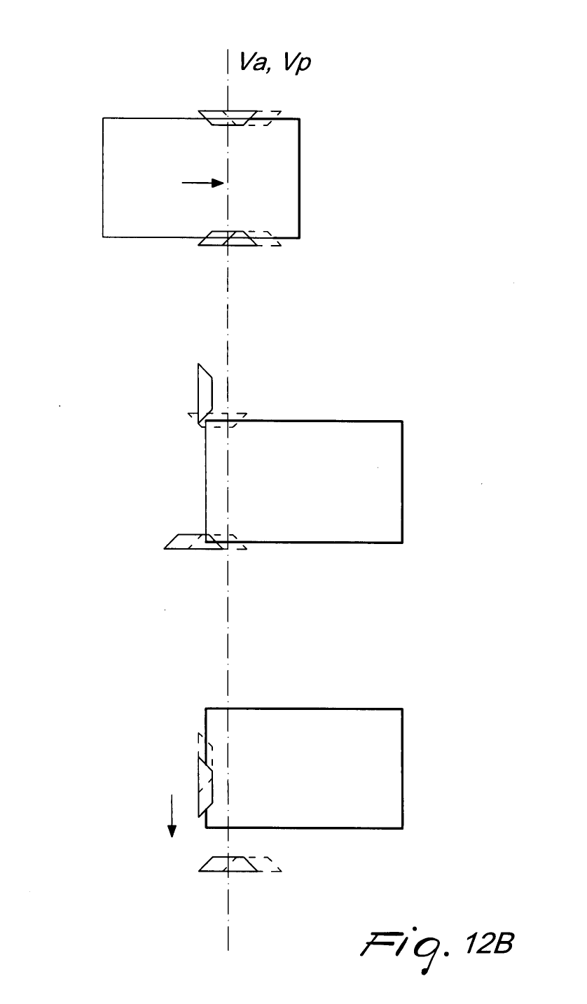

These conventions and numberings are given in FIGS. 13A-13D. The terms “front” and “rear” refer to the direction of the flow of the material being worked (the glass pane 1) within the double-glazing unit production line. The terms “front” and rear” are also used for tools, but in this case with reference to the face of the glass pane 1 and to the position of the operator.

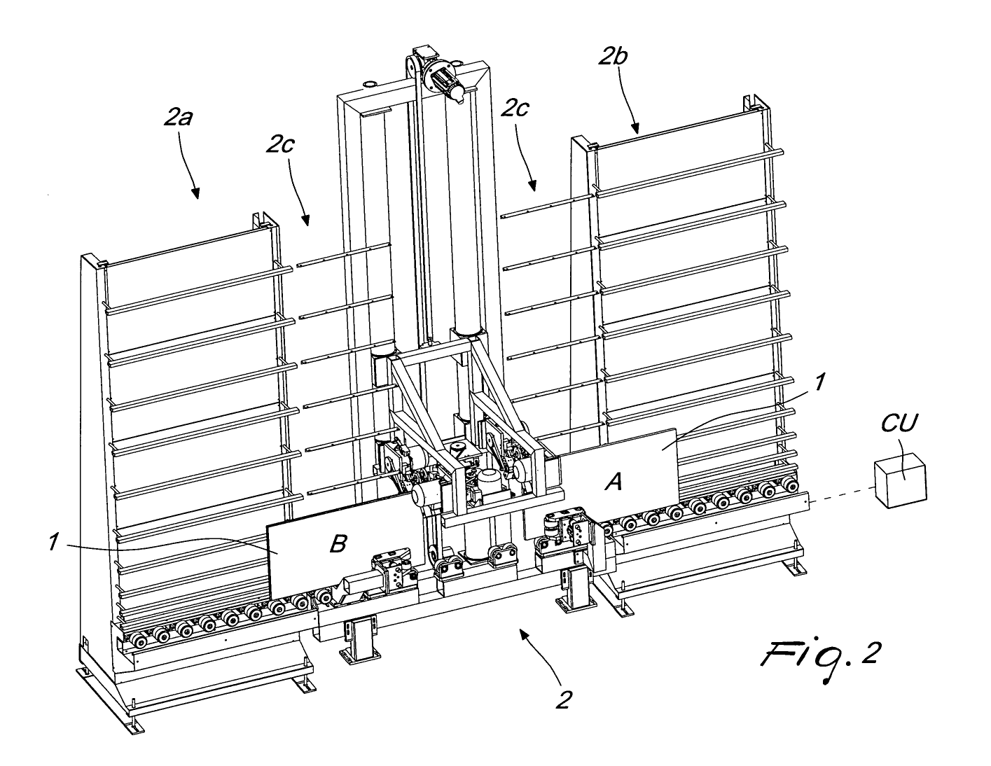

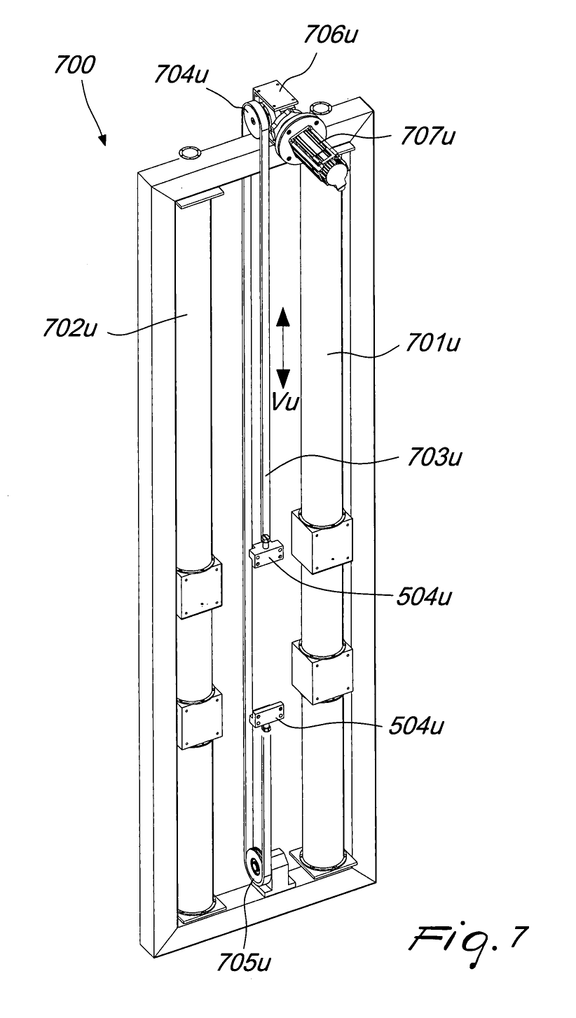

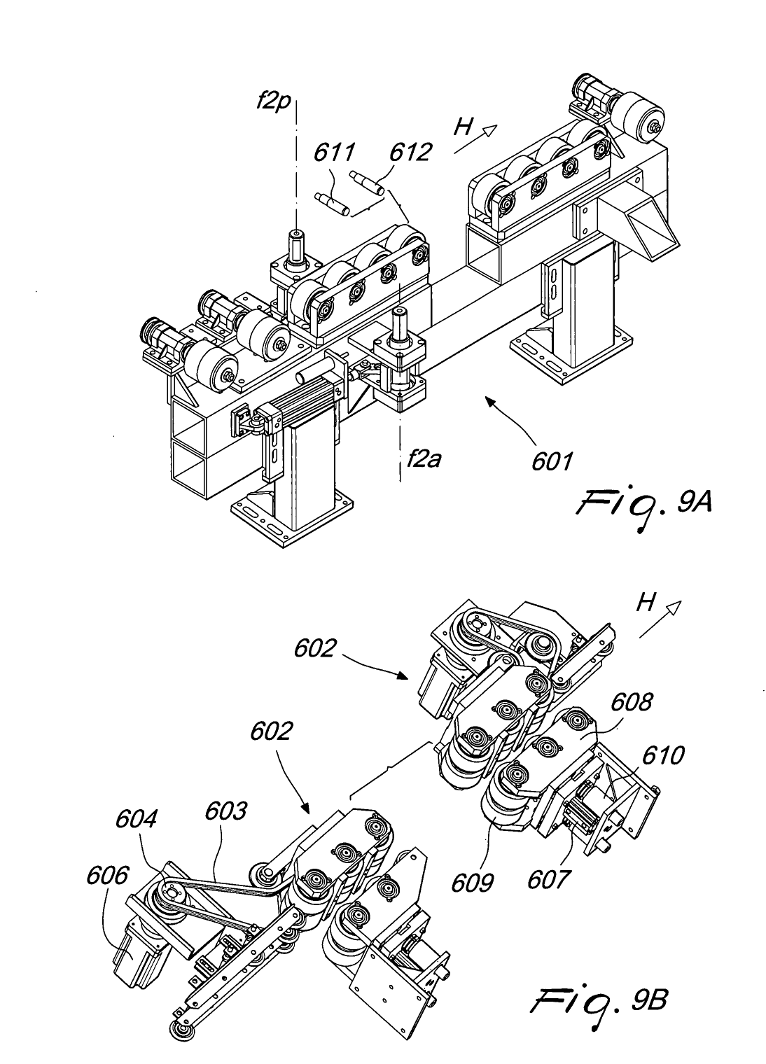

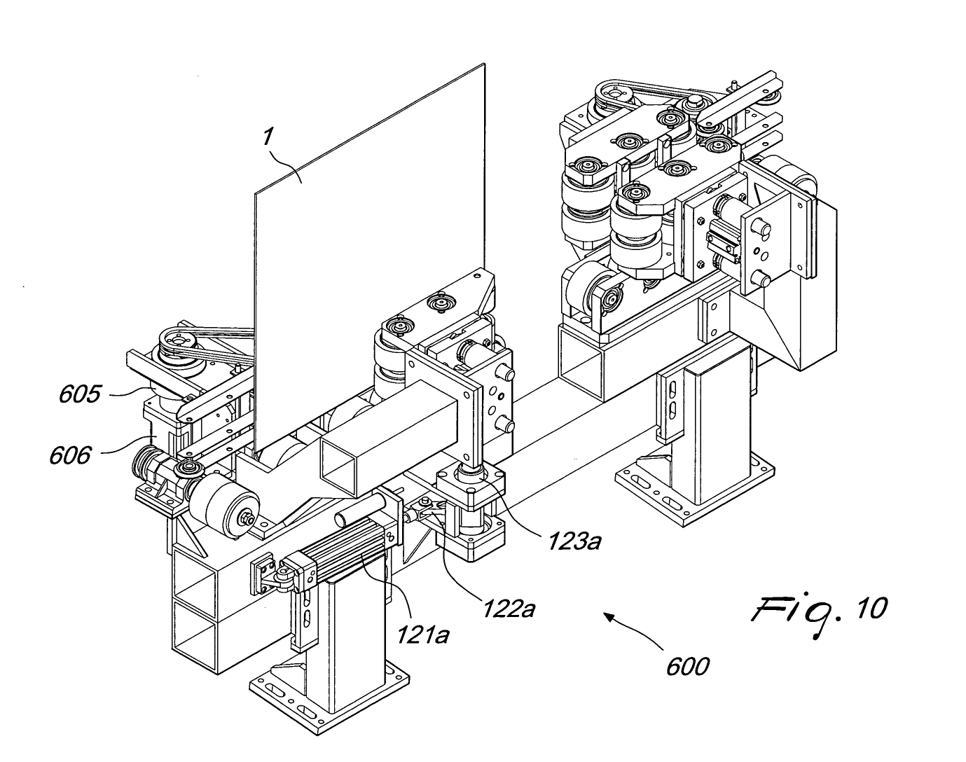

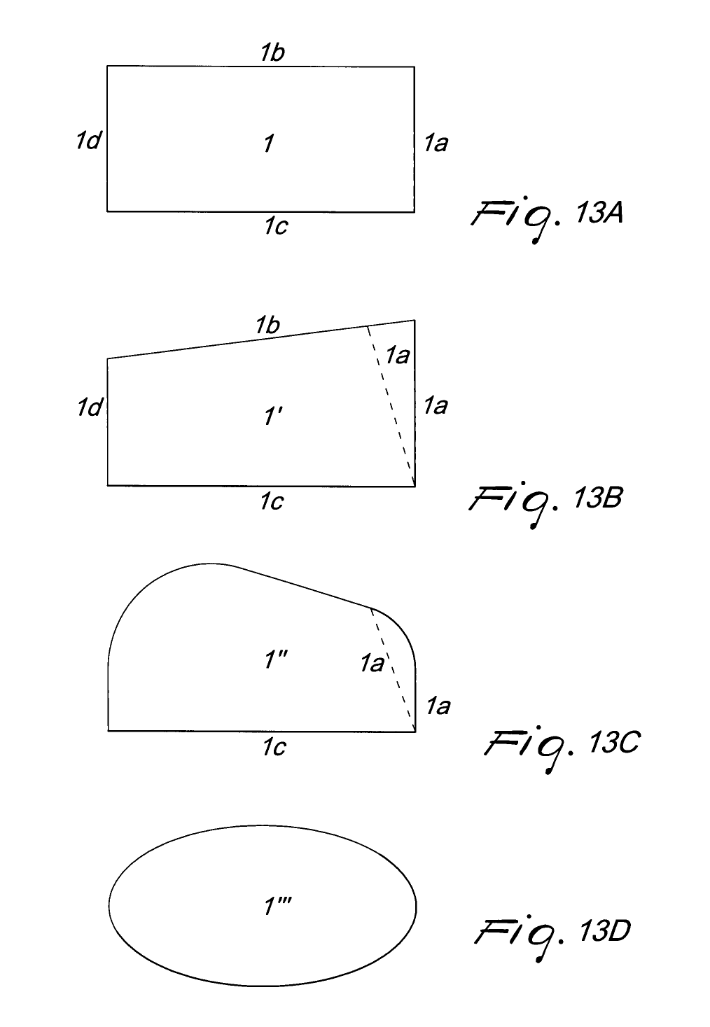

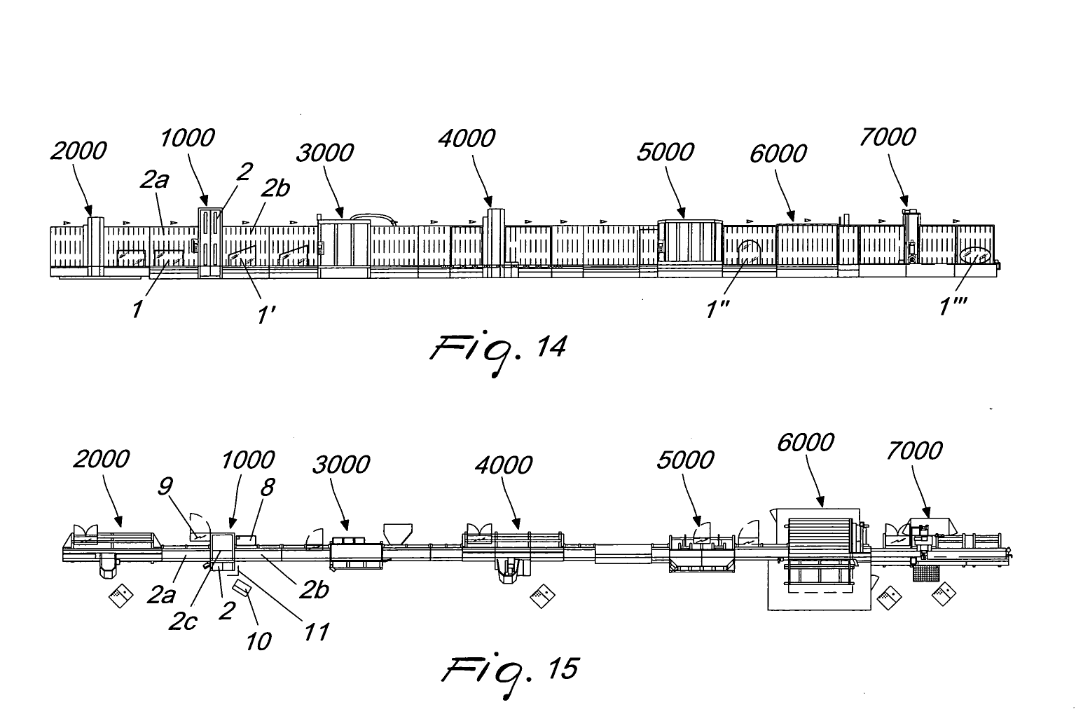

With reference to FIGS. 2, 3, 4, 5A, 5B, 7, 9A, 9B, 10, 11, 13A-13D, 14 and 15, which relate to the machine according to the first preferred embodiment which is preferred in terms of low cost of construction and process optimization, with respect to the background art, the essential components of said first preferred embodiment of the machine are described hereinafter.

The machine comprises a main body 2, which is connected in sequential arrangement between two conveyors 2a and 2b arranged respectively upstream and downstream of the machine body 2.

An input conveyor 2a can be connected to an upstream working section, for example the section for cutting the glass into panes or the edging machine, or as an alternative the glass pane 1 to be ground can also be loaded manually or by controlling a handling unit onto the input conveyor 2a.

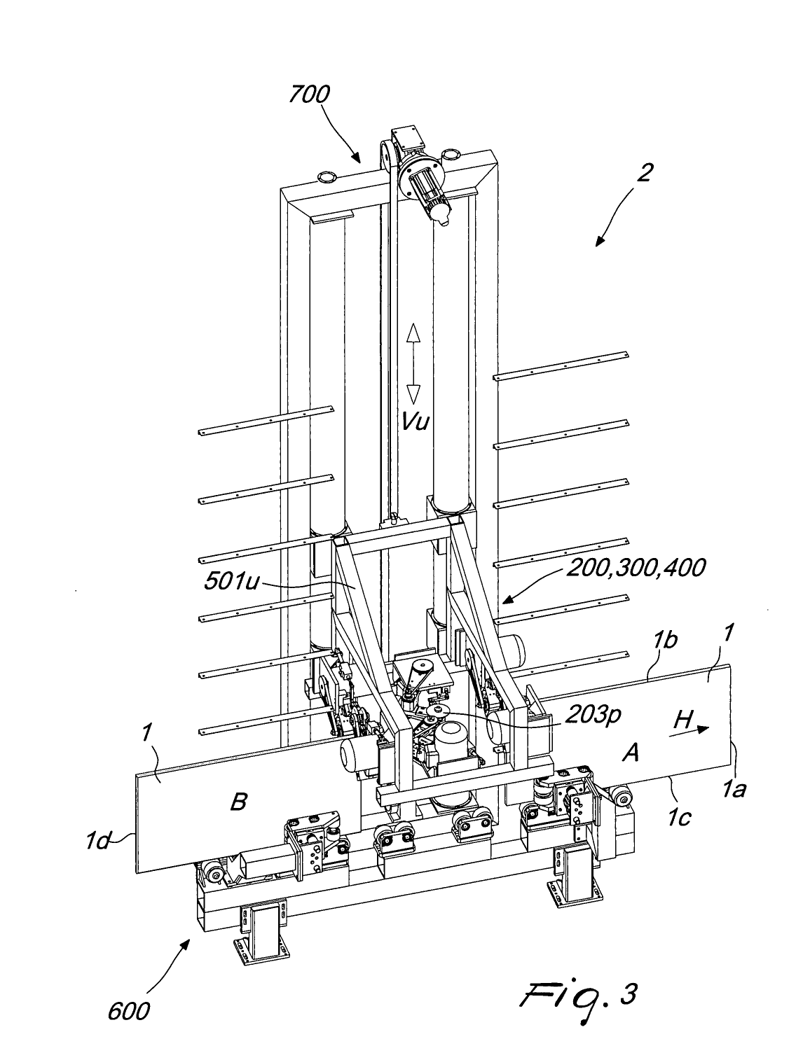

An output conveyor 2b can instead be connected to a downstream working section, for example the section where the manufacture of the double-glazing unit begins, in particular the washing unit. Both conveyors, as well as the central machine body, keep the pane at an inclination of approximately 6° with respect to the vertical, as shown in FIG. 3.

The machine can also be used autonomously, for example for the grinding of glass panes independently of subsequent work, i.e., without being connected to other machines.

The input conveyor 2a comprises a base for supporting the lower edge of the glass pane, on which there is a series of motorized supporting and conveyance rollers of the known type. The conveyor further comprises a supporting surface on which the glass pane is rested substantially vertically in the direction shown above.

The conveyors are known extensively and therefore are not discussed here in detail. It is therefore straightforward to understand that the output conveyor 2b is substantially similar to the input conveyor.

The input conveyor comprises preferably a thickness detector of a known type for measuring the thickness of the glass pane to be worked before it enters the grinding sections, in order to provide a signal for the initial movement of the abrasive tools toward the glass pane 1 as a function of its thickness.

The machine body 2 comprises a section 2c of the known type, which is constituted by a supporting surface with a substantially vertical arrangement with free wheels for the support and sliding of the glass pane 1.

The term “substantially vertical” as used herein is intended to include also slight inclinations from the vertical, that are within the range of approximately ±6°.

The working heads are identified by the sections 100 (which also represents the sections 200, 300, 400) and 500 and are described in detail hereinafter, since they constitute an inventive issue of the subject of the present application.

The machine body 2 comprises a section 600 which comprises in a preferred but not exclusive embodiment, a conveyor 601 with rollers which are partially motorized and partially free, of the known type with horizontal axes for supporting the glass pane 1, and conveyors with mutually opposite motorized rollers 602 which have vertical axes for forced conveyance of the glass pane 1 toward the tools that work the horizontal sides and for its retention when the tools for working the vertical sides are active.

The machine body 2 further comprises a section 700 which produces the vertical movement, along the axis Vu, of the pairs of working heads.

The glass pane 1 that arrives from the previous processing machine (or is loaded manually or by means of a handling unit onto the input conveyor 2a of the machine) is made to advance to the grinding station, being conveyed by the support and conveyance rollers such as 601 of the conveyor 2a of the body 2 and by the motorized driving rollers 602, which all belong to the machine body 2.

For continuity of vertical support, the vertical plane with free wheels for sliding of the input conveyor 2a and output conveyor 2b are continued from the section 2c described earlier.

The mutually opposite forces for retaining the glass pane 1 and allow effectiveness of its movement by a driving chain 603 that acts on pinions 604 and is actuated by means of a reduction unit 605 by a synchronous motor 606 are obtained by way of the action of a pneumatic cylinder 607, which pushes a truck 608, which is provided with a set of mutually opposite free rollers 609, which can move along guides 610.

According to the mechanism described above, the glass pane 1 is thus conveyed along the horizontal axis H to the section in which the pairs of working heads 100, 200, 300, 400 described hereinafter work.

Said control of the position of the glass pane 1 is important for the correct operation of the process performed by the sets, in particular pairs of working heads 100, 200, 300, 400, as will become apparent from the continuation of the description, and if the glass panes to be worked are contoured differently from a rectangle, the conveyor 600 is no longer of the type with rollers, which can be deformed and therefore do not maintain timing, but of a synchronous sucker-fitted carriage type, known in the field, so as to coordinate the horizontal movements on axis H of the glass pane 1 and the vertical movements Va and Vp (a case which can be implemented only in the next second preferred embodiment of the machine) of the working heads which is required to make the grinding tool be always mated with the perimeter of the glass pane 1 which has a nonrectangular shape (1′,1″, 1′″ as shown in FIGS. 13A-13D).

Once the vertical edge 1a of the glass pane 1, synchronized by way of the actuations described above, has arrived at a slowing sensor 611, the motion of the pane is slowed down until it stops completely when said vertical edge is at a stop sensor 612.

The description of the essential components of the first preferred embodiment of the machine is referenced here, since the preamble developed up to now is common for the two embodiments that will be described.

With reference to the grinding station, the movement of the pairs of working heads 200, 300, 400 along the vertical axis Vu along the vertical upright 701u is obtained by means of a slider 501u, which is provided with a series of ballscrew sleeves of the type of 502u which can move on cylindrical guides of the type 701u. The actuation, which is single, of the vertical axis Vu is obtained by means of a chain 703u, which is connected to the slider 501u by means of a plate 504u, a toothed driving pinion 704u, a toothed guiding pinion 705u, an angular reduction unit 706u, a synchronous motor 707u.

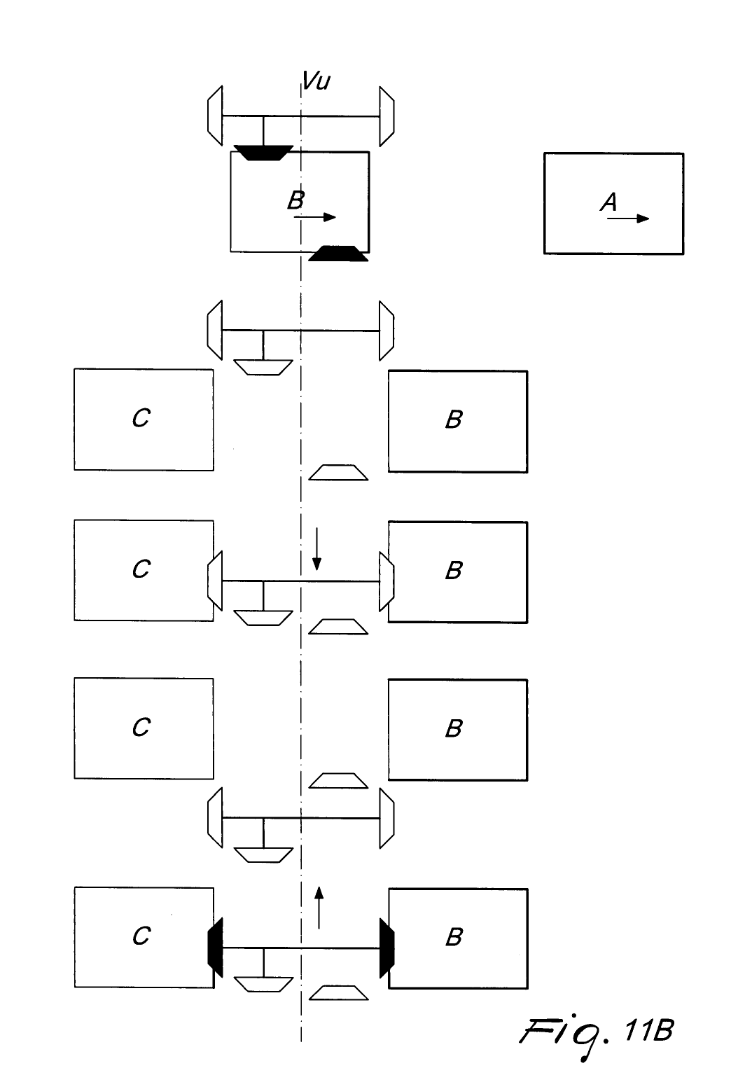

The pairs of working heads 300, 400 (and also the pair 200, which is not active, however, as regards the approach and cutting movements) are moved in order to obtain the feed motion along the vertical sides of the glass pane by means of the controller of the PID type of the synchronous motor 707u, so as to perform grinding along the rear vertical side 1d of the outgoing glass pane 1, referenced by the reference letter A in the figure, and along the front vertical side 1a of the incoming glass pane 1, which is designated by the reference letter B in the figure (see FIGS. 11A and 11B). Once the vertical working stroke has been completed and an overtravel has been performed so as to bring the pair of working heads 200 at the horizontal upper side 1b of the incoming glass pane 1 by detecting the edge of the glass pane with the sensor 505u and the slider 501u has consequently stopped, in the mutually opposite horizontal sides 1b and 1c the pairs of working heads 200 and 100 respectively become active simultaneously, except for their mutual offset, the head 100 being kept stationary and the head 200 being kept in position at the corresponding height so that the active faces of the tools 203a and 203p mate with the arrises of the side 1b of the glass pane 1 to be ground, while the glass pane 1 is moved in its feeding motion by the conveyor of the section 600 (in particular of the section 602) described earlier.

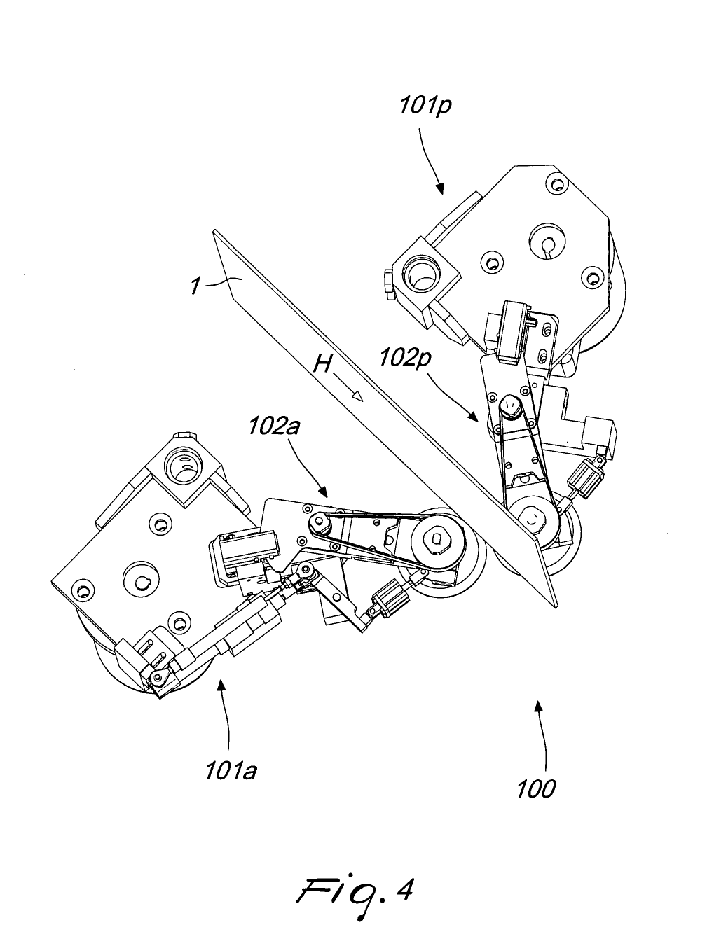

In all the steps, i.e., related to the sides 1a and 1d or to the sides 1b and 1c, grinding occurs advantageously symmetrically on both arrises of the edge of the glass pane 1, as shown in FIG. 4, because the tool, provided with a cutting motion, works by floating toward the arris of the glass pane 1.

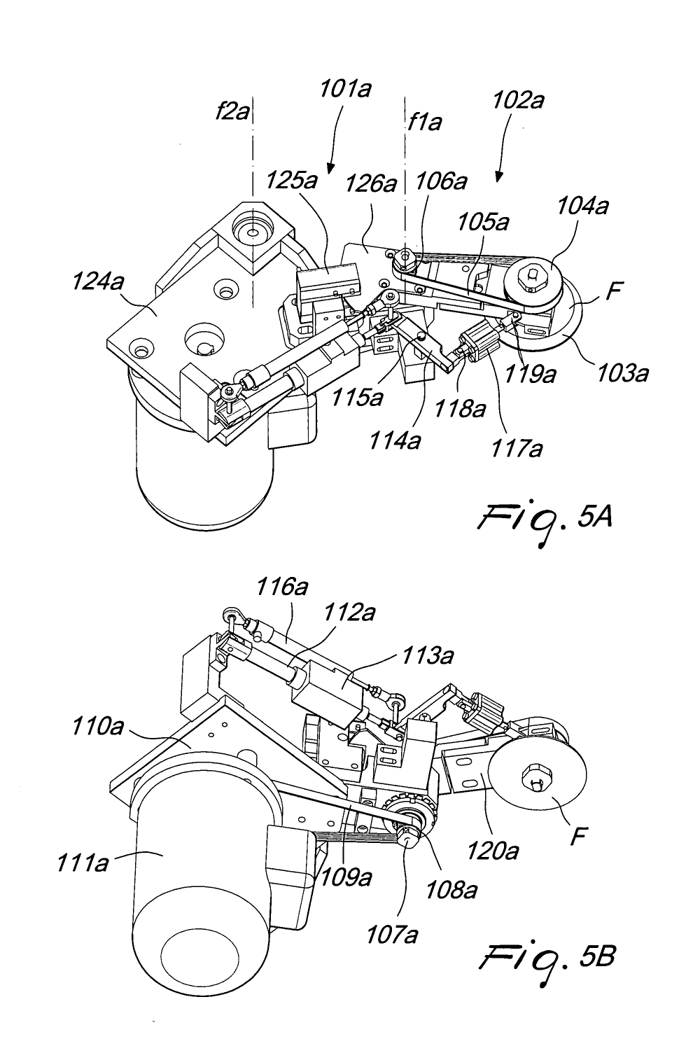

To describe the mechanisms that actuate the cutting motion of the tools, said floating motion and other functions, reference is made to FIG. 5, which relates to the working head 101a, which contains the floating system 102a, this situation being common to all the remaining working heads of the series 101p, 201a, 201p, 301a, 301p, 401a, 401p.

The following classes of movement can be identified in FIG. 5 simply by observing the mechanisms:

cutting motion of the tool;

traverse of the floating system 102a, which allows what was described earlier as adjustment motion, about the axis f1a;

braking of the floating arm;

tilting of the entire working head 101 a about the axis f2a;

which must be described individually in order to simplify their comprehension.

The cutting motion is transferred to the tool 103a by means of the kinematic chain constituted by a pulley 104a, a belt 105a, a pulley 106a, a shaft 107a, a pulley 108a, a belt 109a, a pulley 110a, the drive being constituted by a motor 111a, which is controlled by means of remote switches and a control logic unit which are contained in an electrical/electronic panel 9.

The traverse of the floating system 102a has two components: the first one for adjustment, in order to arrange or set the working field of the tool as a function of the thickness of the glass pane (measured in the input conveyor 2a, as mentioned earlier), which is performed by a pneumatic cylinder 111a provided with a stem locking device 112a which acts on a lever 113a and is pivoted on a pivot 114a with a feedback signal by means of a potentiometer 11 5a in order to set the selected positioning height; the second component for soft oscillation, in order to adapt to the irregularities of the arris of the glass pane (the ones of FIGS. 16 and 17, which have already been commented), which is performed by a pneumatic cylinder 116a, which is pivoted between pivot 117a, which belongs to the lever 113a, and pivot 118a, which belongs to an arm 119a for supporting the tool 103a, containing known minor transmission elements, said arm being pivoted about the axis f1a, which is the same as the shaft for transmitting the cutting motion, so as to eliminate or in any case reduce the action of the force that acts on the transmission belt on the “softness” of the oscillation.

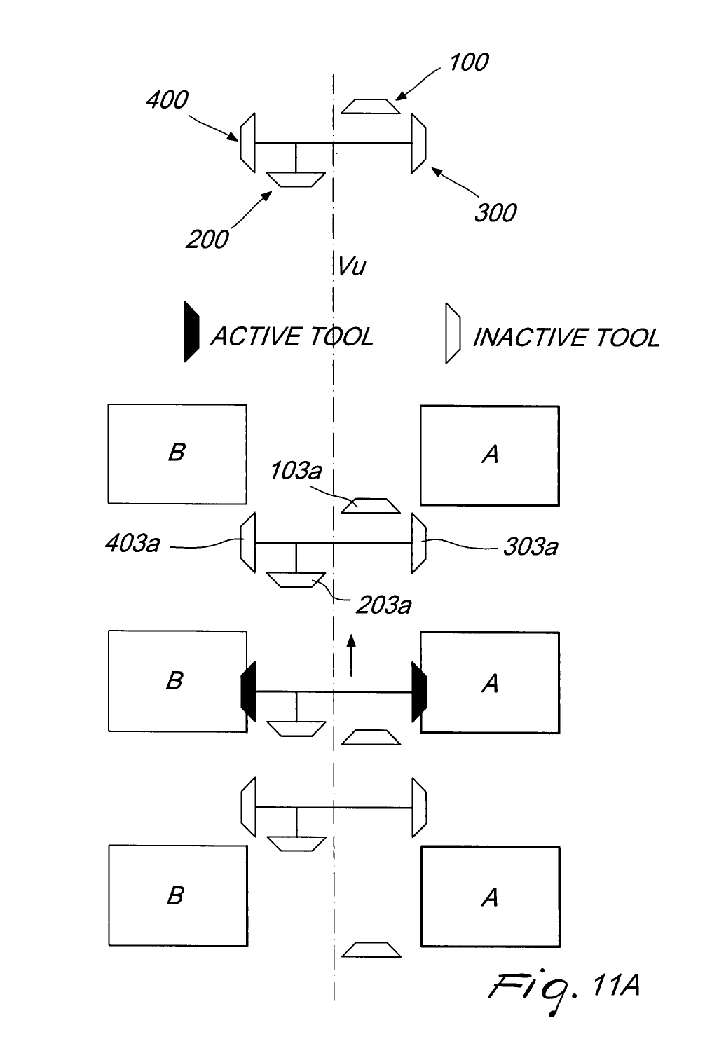

The tilting of the entire working head 101a about the axis f2a is intended to move away the entire working head 101a when the working heads, of the series 300 in this first preferred embodiment or of the series 200 in the subsequent second preferred embodiment, are working in the part of the end of the vertical side in a downward direction. This movement is performed by means of a pneumatic cylinder 120a, which acts on a lever 121a which turns a shaft 122a, shown in FIG. 10, which is rigidly coupled to a plate 123a in f2a.

The braking of the floating arm 19a, actuated by means of a pneumatic brake 124a which acts on a plate 125a which belongs to the arm 119a, is intended to retain in the fixed position the tool 103a, inhibiting the function of the pneumatic cylinder 116a during the grinding of the last millimeters of the side, since otherwise the action of the cylinder 116a at the arris that joins for example the side 1c to the side 1a would entail an unaesthetic rounding of said arris; said brake also acts in accidental stoppages of the machine to prevent the cutting motion of the tools and the thrust of the cylinder 116a from forming a deeper notch into the arrises of the glass pane 1.

An essential characteristic of the movement of the floating arm 119a and 119p is that it occurs in such a configuration as to keep the faces of the tool 103a, 103p, 203a, 203p, 303a, 303p, 403a, 403p, designated by the reference letter F in FIG. 5, perpendicular to the face of the glass pane, so that the action of the active part of said tools, indeed due to the floating behavior, occurs as shown schematically in FIGS. 16a and 16b, where the abnormal behavior of some background art (on the left in the figures) is compared with one of the innovative characteristics of the present invention: i.e., the provision of uniform beveling of the arrises of the glass pane 1 (as shown in the right part of the figures) by way of the fact that despite the irregularities of the arris of the glass pane 1, due to the cutting operations, the active part of the tools adapts thereto indeed by way of the oscillating movement allowed by the floating arm 119a, 119p and the “soft” thrust of the cylinder 116a, 116p.

The machine according to the invention further comprises a control unit CU that is provided with dedicated software that is suitable to control tilting movement of the abrasive tools about said vertical axes Va, Vp, Vu when working of horizontal sides 1b, 1c of the glass pane is carried out and to control tilting motion of the glass pane 1 about a horizontal axis H so as to provide uniform wear of the abrasive tools all over an active surface thereof.

Furthermore the software is suitable to control simultaneous tilting of the abrasive tools 203a, 203p about said vertical axes Vu, Va, Vp and of the glass pane 1 about said horizontal axes, when the glass panes 1 that are worked have a shape that is different from the rectangular one.

Having described all the essential components of the first preferred embodiment of the machine, the working process is now described (said process corresponding to the diagrams of FIGS. 11A and 11B, in the following options, all of which are possible by using the described mechanisms, a logic system for controlling them, and software for managing said logic system).

All the descriptions begin from the position, already described, in which the glass pane (1, 1′, 1″, but in this mode of operation only 1) is stopped at the stop sensor 612.

SINGLE OPTION: working a rectangular glass pane 1.

The configuration of the mutually opposite pairs of working heads is shown schematically at the beginning of FIG. 11 by single lines with the connection of the heads 200, 300, 400 to identify the working heads which can move vertically monolithically along the single vertical axis Vu and with the mutually opposite working heads 100 in a fixed condition; in the glass panes being worked, the part of the edge of the glass pane 1 that has undergone grinding is shown in thicker lines. By following the steps in the progression of the diagrams, it is straightforward to identify the process in its simplicity (which resides in that it has multiple working heads which can move along a single axis):

position for waiting for the beginning of the cycle for the pane B and for waiting for the completion of the cycle of the glass pane A;

vertical upward movement of the multiple-head slider and working of the vertical side 1d of A and of the vertical side 1a of B by means of the heads 300 and 400;

placement of the multiple-head slider to prepare for working the horizontal side 1b of B together with the working of the horizontal side 1c of B;

working of the horizontal sides 1b and 1c of B;

waiting for the positioning of the glass panes B and C;

inactive descent of the multiple-head slider;

the last two steps are equivalent to the first two, but relate to the new situation with a glass pane B at the end of work and of a glass pane C at the beginning of work.

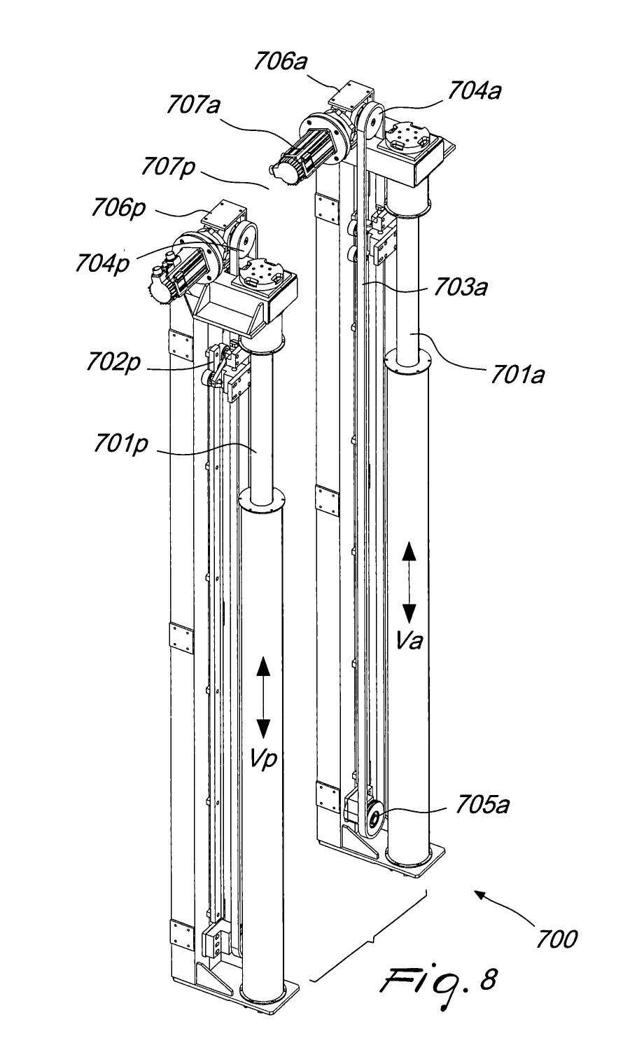

With reference to FIGS. 4, 5A, 5B, 6, 8, 9A, 9B, 10, 12A, 12B, 13A-13D, 14 and 15, which relate to the machine according to the second embodiment, which is still valid in terms of low cost of construction with respect to the machines of the background art but is not as low in cost as the first embodiment, the essential components of said second preferred embodiment of the machine are described hereinafter.

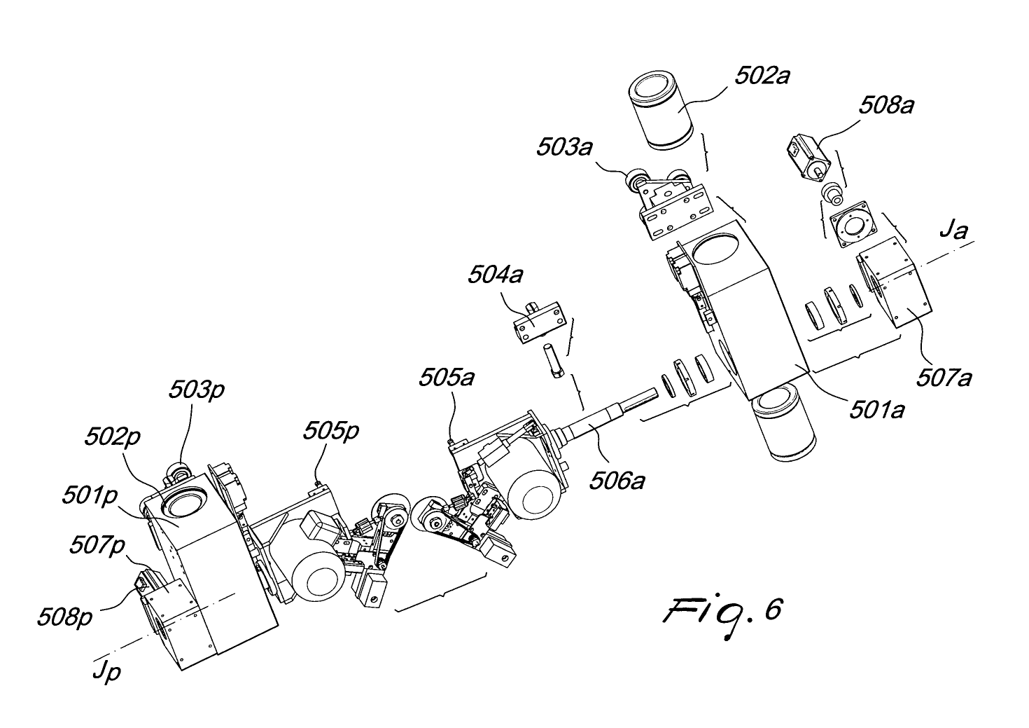

Said components consist in using two pairs of working heads instead of four: 100, with a lower fixed arrangement, and 200, the working heads 200a and 200p of which being able to move vertically on vertical axes Va and Vp which are independent. The components of said working heads have already been described in the first embodiment and any further description is superfluous, except for what relates to the rotation of the working heads 201a and 201p about their respective axes *a and *p as shown in FIG. 6; likewise, the description is not repeated for the sections 2, 8, 9, 10, 11, since they are common to the two embodiments.

The mechanisms for the rotation of the working heads 201 a and 201p are the ones that belong to the sliders 501a and 501p (FIG. 6) and consist of the shafts 506a and 506p (506p is not indicated, and therefore the subsequent items with the index p are omitted hereinafter), which are rigidly coupled to the plate 123a (shown in FIG. 5) and are free to rotate about the axis Θa by means of bearings which are contained in the slider 501a, actuated by the reduction unit 507a and the synchronous motor 508a. This rotation allows to orient the working head 201a and, by way of the corresponding mechanisms, the working head 201p and with them the tools 203a and 203p, so as to mate with the perimeter of the glass pane 1, successively performing rotations through 90° in the case of glass panes which have a rectangular shape 1, progressively by means of the interaction and interpolation of the axes H, Va, Vp, Θa, Θp in the case of glass panes which have a nonrectangular shape 1′, 1″, 1′″.

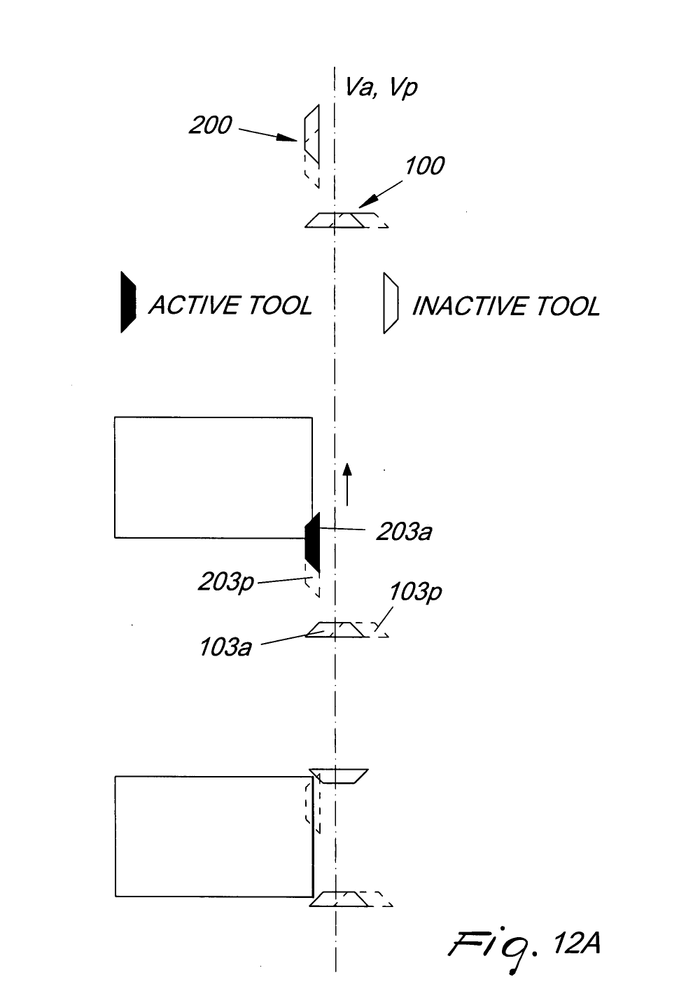

Having described all the essential components of the second preferred embodiment of the machine (or rather the ones that differ from those of the first embodiment), the working process (which corresponds to the diagrams of FIGS. 12A and 12B) is now described in the following options, all of which are possible by using the described mechanisms, a logic system for controlling them, and software for managing said logic system:

OPTION 1: working a rectangular glass pane 1

OPTION 2: working a glass pane 1′ with a rectilinear contour

OPTION 3: working a glass pane 1″ with a curvilinear contour

OPTION 4: working a glass pane 1′″ with a curvilinear contour

All the descriptions start from the already-described position in which the glass pane (1, 1′, 1″) is stopped at the stop sensor 612. Reference is also made to the reference numerals of the components so as to complete, in the same description, the aspects related to the machine claims.

OPTION 1: the diagrams of FIGS. 12A and 12B illustrate, as anticipated in the description of the figures, both the front tools and the rear tools in order to point out the reason why both the front vertical axis Va and the rear vertical axis Vp are necessary (the same applies for Θa and Θp), since the front and rear tools do not exactly match up with each other, in order to not interfere with each other; the rotations for this first option and for the subsequent options to make the orientation of the tools tangent to the subsequent side must occur at different times.

The process therefore occurs simply according to the following steps:

working of the vertical side 1a by means of the tools 203a, 203p by means of the axes Va, Vp actuated by the respective motors 707a, 707p

rotation of the tools 203a, 203p (each at the arris of intersection of the side 1a with the side 1b) by means of the motors 508a, 508p which produce the finite rotation through 90° (therefore without interpolation of axes but only upon clearance that the position has been reached)

simultaneous working of the sides 1b and 1c by the tools 203a, 203p, 103a, 103p after arranging in contact said last pair, with the tools in a stationary position and the glass pane 1 conveyed along the axis H by the synchronous motor 606 (which however can also work as an asynchronous motor and stop upon a pane start and pane stop signal)

rotation of the tools as in the penultimate step

working of the vertical side 1d after moving away the tools 103a, 103p.

OPTION 2: everything proceeds as in the description of option 1, except that in order to follow the inclination of some sides, for example the nonvertical side 1a, the nonhorizontal side 1b, et cetera, the axes H, Va+Vp, Θa+Θp work by interpolation by means of the concatenated actuation of the motors, which now work synchronously, 606, 707a, 707p, 508a, 508p. As regards the axes Θa+Θp, they are intended to orient the tools 201a, 201p so that they are tangent to the polygonal broken line to be followed. The concatenation of said motors occurs by means of electronic actuation systems managed by software, said software having received as inputs all the information related to the shape 1′ of the glass pane, by way of known matters such as barcodes, databases, et cetera. The lower side, which for these shapes must be horizontal, is instead worked nonsynchronously by the tools 103a, 103p, while the glass pane 1′ moves along the axis H.

OPTION 3: everything proceeds as in the description of option 2, except that in order to follow the inclination of some sides, for example nonhorizontal or nonvertical sides 1a, and the curvilinear shape of some other sides, the axes H and Va+Vp, Θa+Θp work by interlacing by means of the concatenated actuation of the motors, which now operate synchronously, 606, 707a, 707p, 508a, 508p in the case of rectilinear sides in the manners described in option 2; while the axes H, Va+Vp, Θa+Θp operate by interpolation by means of the concatenated actuation of the motors, which now operate synchronously, 606, 707a, 707p, 508a, 508p with continuous variation of the axes Θa+Θp to orient the tools 201a, 201p so that they are tangent to the curvilinear shape to be followed. Concatenation of these motors occurs by means of electronic actuation systems managed by software, said software having received as inputs all the information related to the shape 1″ of the glass pane, with known methods such as barcodes, databases, et cetera. The lower side, which for these shapes must be horizontal, is instead worked nonsynchronously by the tools 103a, 103p while the glass pane 1″ moves along the axis H.

OPTION 4: for this option, only the pair of working heads 200 is active and the glass pane is supported and conveyed only by at least one sucker, which is not shown but is described as associated with the synchronous axis H and the interpolated axes H, Va+Vp, Θa+Θp, are actuated by the motors 606 (or rather equivalent to 606), 707a, 707p, 508a, 508p.

It goes without saying that industrial application is certain to be successful, since glass pane arrissing machines are currently not very widespread. Moreover, the double-glazing unit market is continuously expanding, since in recent years it has been increased by all the configurations that require the use of special glass panes, such as the ones described in the introduction (and in particular tempered glass panes which require arrissing as a preparatory step for tempering), and therefore arris beveling is an added value which is very important and qualifies the product. Moreover, the diffusion of the shapes which are nonrectangular because they are polygonal or curvilinear or mixed, increases even more the importance of a version of the present invention, in contrast with the limitation of traditional machines which can work only rectangular shapes.

The particular arrangement of working heads, such as the one shown in FIG. 12, of the machine according to the present invention has further substantially halved cycle times with respect to EPA. 04013951.1.

Moreover, a sector that is expanding every day and also requires the grinding of arrises or of the entire perimetric contours of glass panes 1 is the tempering of glass in many applications which are different from those of the double-glazing unit sector. For this application, the machine can assume a vertical or horizontal arrangement.

It has thus been shown that the machine and machines according to the invention achieve the intended aim and objects. The invention is susceptible of numerous modifications and variations, all of which are within the scope of the appended claims. Thus, for example, the mechanical solutions for the motions for feeding the tools, the support and movement of the glass pane and the actuation means can be electrical, electrical-electronic, pneumatic, hydraulic and/or combined, while the control means can be electronic or fluidic and/or combined.

An important constructive variation is the one constituted by the logic combination of the actuations respectively for translational motion of the glass pane, for movement of the working heads so as to allow the working of contoured glass panes, i.e., panes having nonrectangular shapes. To achieve this, as described earlier, the electrical actuation systems of the motors dedicated to the axes H, Va, Vp, Z are concatenated by means of an electrical axis with a numeric control system.

Moreover, the tools 103a, 103p, 203a, 203p, 303a, 303p, 403a, 403p can have a shape other than frustum-like in order to give the bevel obtained by grinding a profiled shape instead of a flat shape.

The constructive details may be replaced with other technically equivalent ones. The materials and the dimensions may be any according to requirements, in particular those that derive from the dimensions (base and height) of the glass panes 1.

The disclosures in Italian Patent Application No. TV2006A000184 from which this application claims priority are incorporated herein by reference.

What is claimed is:

1. An automatic machine for grinding perimeter arrises of substantially flat rectangular glass panes arranged vertically, comprising: a machine body provided with a supporting surface suitable to allow vertical sliding and with a horizontal conveyor; at least two pairs of working heads supported on the machine body so as to be movable with respect to said glass pane along perimeter arris thereof, each working head comprising a tool body which is movable transversely to a lying plane of said pane, each tool body comprising an abrasive tool shaped as a rigid frustum-shaped grinding wheel which rotates with a cutting motion to perform grinding; a guide which is rigidly coupled to said machine body; and a single slider which runs on said guide; said at least two pairs of working heads being jointly movable along a single vertical axis by way of said single slider that runs on said guide.

2. The machine of claim 1, wherein said working heads are actuatable to provide approach toward the arris of the glass pane of each of the abrasive tools independent of an approach toward the arris of the glass pane of a corresponding opposite abrasive tool.

3. The machine of claim 1, wherein moving of said abrasive tools for approach thereof to the glass pane, oscillation of the tools and thrust toward the arris of the glass pane do not involve components other than the tools themselves, supporting arms thereof, minor cutting motion transmission elements and minor pusher elements contained in said arms, and exclude any component which generates power required for a cutting motion.

4. The machine of claim 3, wherein said heads comprise respective arms, transverse oscillation whereof occurs about an axis which corresponds to an axis of a shaft for transmitting motion to said abrasive tools.

5. An automatic machine for grinding arrises of a perimeter of substantially flat glass panes arranged vertically, comprising: a machine body having a supporting surface which provides substantially vertical sliding guide; a horizontal conveyor; at least one pair of working heads that are movable with respect to said glass pane along the perimeter thereof, and wherein each of said working heads comprises a tool body which is movable substantially transversely to the plane of said pane, each tool body comprising an abrasive tool with a rigid grinding wheel which is frustum-shaped and rotates with a cutting motion in order to perform grinding; and sliders which run along guides which are rigidly coupled to said machine body, said working heads being connected to said sliders and individually and independently movable, along respective vertical axes by way of said sliders.

6. The machine of claim 5, comprising at least two pairs of working heads, with a first pair of working heads that is fixed, and a second pair of working heads that is movable individually and independently along respective vertical axes along said sliders which run along said guides which are rigidly coupled to said machine body.

7. The machine of claim 5, wherein said working heads are orientable along axes which are perpendicular to the glass pane.

8. The machine of claim 5, wherein each one of said working heads that is located in a front position with respect to the glass pane is suitable to come into contact with edges of said glass pane independently of a corresponding one of said working heads that is located in a rear position with respect to the glass pane.

9. The machine of claim 5, wherein said working heads are provided and are actuatable so that arrangement of a said tool adjacent to the glass pane, an oscillation and thrust thereof toward the arris of the glass pane involve only components of the tool itself, a supporting arm thereof, minor transmission elements contained in said arm and exclude any component which generates power that provides cutting motion of the tool.

10. The machine of claim 5, wherein said conveyor is a synchronous sucker type conveyor and is suitable to perform a motion that is combined with a motion of the working heads of said at least one pair of working heads, whereby grinding occurs along contours of the glass pane which are other than rectangular.

11. The automatic machine of claim 5, wherein said abrasive tool is a diamond grinding wheel.

12. The automatic machine of claim 11, wherein said diamond grinding wheel has a frustum shape.

13. The automatic machine of claim 9, wherein the supporting arm of said tool is lockable in a position adjacent to the arrises of the glass pane.

14. The automatic machine of claim 13, wherein the frustum-shaped tools are arrangeable adjacent to the arrises of the glass pane while keeping the faces thereof perpendicular to a face of the glass pane.

15. The automatic machine of claim 10, wherein said machine body has a substantially vertical extension, so as to allow insertion of the machine body in a line for working glass panes which are arranged in a substantially vertical position.

16. The automatic machine of claim 5, wherein said pane is arrangeable along a substantially horizontal plane.

17. The automatic machine of claim 5, further comprising a control unit that is provided with dedicated software that is suitable to control tilting movement of the abrasive tools about said vertical axes when working of horizontal sides of the glass pane is carried out and to control tilting motion of the glass pane about a horizontal axis so as to provide uniform wear of the abrasive tools all over an active surface thereof.

18. The automatic machine of claim 17, wherein said software is suitable to control simultaneous tilting of the abrasive tools about said vertical axes and of the glass pane about said horizontal axes.

19. A method for grinding the arrises of the perimeter of a rectangular glass pane comprising the steps for:
simultaneous grinding of a vertical side of the pane and of a vertical side of the pane by way of first and second sets of working heads actuated with an infeed approach to the glass pane, with simultaneous motion along a single vertical axis, while also moving simultaneously along the same axis a third set of working heads;
simultaneous grinding of horizontal sides of the glass pane, by way of said third set of working heads arranged at a height of an upper side of the glass pane and actuated with an infeed approach to the glass pane, and acting on said upper side; and
actuation with an infeed approach to the glass pane of a fourth set of working heads which are stationary at a level of a lower side of the glass pane.

20. The method of claim 19, comprising dividing all said first to fourth sets of working heads between positions at a front part and a rear part of the glass pane; and approaching said sets from the rear and front parts to the arrises of the glass pane independently one from the other.

21. The method of claim 19, wherein at least one of said sets of working heads is actuated with a motion for approach and thrust toward the arrises of the glass pane and wherein actuation for said approach motion is independent from actuation by way of a power element that provides cutting motion of a cutting tool.

22. The method of claim 19, comprising division of all of the sets of working heads between a front part and a rear part of the glass pane; and actuation of the sets of working heads located at each said part of the glass pane to approach the arrises of the glass pane independently of each other.

23. The method of claim 19, wherein at least one of said sets of working heads is actuated for approach and thrust motion toward the arrises of the glass pane, said actuation step being carried out without involvement of power elements that provide tool cutting motion.

24. A method for grinding the arrises of the perimeter of rectangular glass panes comprising the steps for:
grinding of a first vertical side of the pane by way of a first set of working heads which are actuated for an infeed approach to the glass pane;
rotation of said first set of working heads;
simultaneous grinding of horizontal sides of the glass pane by way of said first set of working heads actuated with infeed approach, arranged at the height of an upper side of the glass pane and acting on the upper side of the glass pane;
actuation of a second set of working heads that are stationary at a level of a lower side of the glass pane with an infeed approach;
rotation of said first set of working heads;
grinding of a second vertical side of the glass pane by way of said first set of working heads provided with infeed approach.
